(19) United States
(12) Patent Application Publication
(10) Pub. No.: US 2026/0007929 A1
(43) Pub. Date: Jan. 8, 2026

(54) METHOD AND DEVICE FOR GENERATING, ON BASIS OF SOUND INTENSITY AND RHYTHM PATTERN, EXERCISE PROGRAM CORRESPONDING TO MUSIC

(71) Applicant: Samsung Electronics Co., Ltd., Suwon-si (KR)

(72) Inventors: Heeyoung CHO, Suwon-si (KR); Seungjoon LEE, Suwon-si (KR); Hyunjoo KANG, Suwon-si (KR)

(21) Appl. No.: 19/327,233

(22) Filed: Sep. 12, 2025

Related U.S. Application Data
(63) Continuation of application No. PCT/KR2024/005509, filed on Apr. 24, 2024.

(30) Foreign Application Priority Data
Jun. 19, 2023 (KR) 10-2023-0078337

(51) Int. Cl. A63B 24/00; A63B 21/00; A63B 71/06; G06F 3/01; G10L 15/26

(52) U.S. Cl. CPC A63B 24/0075; A63B 21/00069; A63B 21/4025; A63B 24/0087; A63B 71/0686; G06F 3/016; G10L 15/26; A63B 2024/0096; A63B 2071/0655; A63B 2071/068; A63B 2208/02; A63B 2220/803; A63B 2220/836; A63B 2230/625

(57) ABSTRACT

An electronic device is provided. The electronic device analyzes music so as to extract the sound intensity and the rhythm pattern from the music, generates, on the basis of the extracted sound intensity and the extracted rhythm pattern, guide data for an exercise program corresponding to the music, and can determine the exercise content of the exercise program on the basis of the generated guide data and movement information received from a wearable device connected to the electronic device.

### CROSS-REFERENCE TO RELATED APPLICATION(S)

This application is a continuation application, claiming priority under 35 U.S.C. § 365 (c), of an International application No. PCT/KR2024/005509, filed on Apr. 24, 2024, which is based on and claims the benefit of a Korean patent application number 10-2023-0078337, filed on Jun. 19, 2023, in the Korean Intellectual Property Office, the disclosure of which is incorporated by reference herein in its entirety.

### BACKGROUND

### 1. Field

The disclosure relates to a method of generating an exercise program corresponding to music based on intensity and a rhythm pattern of sound.

### 2. Description of Related Art

Various types of wearable devices that a user may wear on their body part have been developed according to the purpose of the wearable devices, such as a type that may be worn on a body part, a type that may be worn on the entire body, and a type that replaces a body part. Specifically, wearable devices may be often developed to assist an older user in performing a specific action. For example, the wearable device may be developed to rehabilitate a body part or to replace the body part when the body part fails to function.

The wearable device may assist an action performed by a body part by applying an assistance force to a body motion in a direction that is the same as a direction in which the body part of the user who wears the wearable device moves using an actuator or may strengthen the body part by applying a resistance force to the body motion in a direction that is opposite to the direction in which the body part of the user moves. The wearable device may store an operation of the actuator as the operation is programmed in advance and may drive the actuator according to the stored operation.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method of generating an exercise program to music based on intensity and a rhythm pattern of sound.

Additional aspects will be set forth in part in the description which follows and, in part, will be apparent from the description, or may be learned by practice of the presented embodiments.

In accordance with an aspect of the disclosure, an electronic device is provided. The electronic device includes communication circuitry connected to a wearable device to receive sensor data including motion information of the wearable device, memory, comprising one or more storage media, storing instructions, one or more processors electrically connected to the communication circuitry and the memory, wherein the instructions, when executed by the one or more processors individually or collectively, cause the electronic device to extract a sound intensity and rhythm pattern in target music by analyzing the target music, based on the extracted sound intensity and the extracted rhythm pattern, generate guide data on an exercise program corresponding to the target music, and based on the generated guide data and motion information received from the wearable device, determine exercise content of the exercise program.

The instructions, when executed by the one or more processors individually or collectively, further cause the electronic device to, based on the extracted sound intensity, generate intensity guide data on an exercise intensity to be applied to the wearable device when the exercise program is executed. The processor is configured to, based on the extracted rhythm tempo, generate tempo guide data on haptic feedback to be generated in the wearable device when the exercise program is executed.

The instructions, when executed by the one or more processors individually or collectively, further cause the electronic device to extract frequency information on a plurality of notes forming the target music. The processor is configured to identify a chorus interval of the target music based on the extracted frequency information. The processor is configured to correct the generated intensity guide data by correcting an exercise intensity for a note included in the identified chorus interval.

The instructions, when executed by the one or more processors individually or collectively, further cause the electronic device to identify start times of beats in the target music based on the generated tempo guide data. The processor is configured to determine the exercise content of the exercise program such that the haptic feedback is generated in the wearable device at some of the identified start times when the exercise program is executed.

The instructions, when executed by the one or more processors individually or collectively, further cause the electronic device to play the target music after generating the guide data, and receive the motion information of the wearable device from the wearable device in real time according to playback of the target music.

The instructions, when executed by the one or more processors individually or collectively, further cause the electronic device to segment an entire playback time of the target music into a plurality of exercise sessions, and determine an exercise mode corresponding to each of the plurality of segmented exercise sessions to be one of a first mode and a second mode.

The instructions, when executed by the one or more processors individually or collectively, further cause the electronic device to, based on determining whether a candidate posture that matches the motion information of the wearable device received while a target exercise session is played exists in a plurality of candidate postures stored in the electronic device, determine an exercise mode corresponding to the target exercise session.

The instructions, when executed by the one or more processors individually or collectively, further cause the electronic device to, when the candidate posture that matches the motion information of the wearable device received while the target exercise session is played exists, determine the exercise mode corresponding to the target exercise session to be the first mode related to the matching candidate posture, and when the candidate posture that matches the motion information of the wearable device received while the target exercise session is played does not exist, determine the exercise mode corresponding to the target exercise session to be the second mode indicating a free posture session.

The instructions, when executed by the one or more processors individually or collectively, further cause the electronic device to, when the exercise mode corresponding to the target exercise session is determined to be the first mode, determine the exercise content of the exercise program such that a resistance force is generated at a position according to an exercise posture that is recorded corresponding to the target exercise session in the wearable device when the target exercise session is played according to execution of the exercise program.

The instructions, when executed by the one or more processors individually or collectively, further cause the electronic device to determine exercise content from a start time to a current time of the target music of the exercise program based on the motion information received from the wearable device, and when a request for automatic generation of the exercise program is received, determine exercise content from the current time to an end time of the target music of the exercise program based on the determined exercise content.

The instructions, when executed by the one or more processors individually or collectively, further cause the electronic device to, when utterance information of the wearable device is received while the target exercise session is performed, determine whether to embed the received utterance information as the exercise content of the exercise program, based on determining whether the received utterance information is an utterance related to the exercise posture recorded corresponding to the target exercise session or an exercise order in the target exercise session.

The instructions, when executed by the one or more processors individually or collectively, further cause the electronic device to, when the received utterance information is embedded as the exercise content of the exercise program, determine the exercise content of the exercise program such that the wearable devices output the received utterance information through text to speech (TTS) when the target exercise session is played according to the execution of the exercise program.

In accordance with another aspect of the disclosure, a method performed by a processor of an electronic device is provided. The method includes extracting a sound intensity and rhythm pattern in target music by analyzing the target music, based on the extracted sound intensity and the extracted rhythm pattern, generating guide data on an exercise program corresponding to the target music, and based on the generated guide data and motion information received from a wearable device, determining exercise content of the exercise program.

The generating of the guide data includes, based on the extracted sound intensity, generating intensity guide data on an exercise intensity to be applied to the wearable device when the exercise program is executed, and based on the extracted rhythm tempo, generating tempo guide data on haptic feedback to be generated in the wearable device when the exercise program is executed.

The determining of the exercise content of the exercise program includes playing the target music after generating the guide data, and receiving the motion information of the wearable device from the wearable device in real time according to playback of the target music.

The determining of the exercise content of the exercise program includes segmenting an entire playback time of the target music into a plurality of exercise sessions, and based on determining whether a candidate posture that matches the motion information of the wearable device received while a target exercise session is played exists in candidate postures stored in the electronic device, determining an exercise mode corresponding to the target exercise session.

The determining of the exercise content of the exercise program includes determining exercise content from a start time to a current time of the target music of the exercise program based on the motion information received from the wearable device, and when a request for automatic generation of the exercise program is received, determining exercise content from the current time to an end time of the target music of the exercise program based on the determined exercise content.

In accordance with another aspect of the disclosure, one or more non-transitory computer-readable storage media storing one or more computer programs including computer-executable instructions that, when executed by one or more processors of an electronic device individually or collectively, cause the electronic device to perform operations. The operations include extracting a sound intensity and rhythm pattern in target music by analyzing the target music, based on the extracted sound intensity and the extracted rhythm pattern, generating guide data on an exercise program corresponding to the target music, and based on the generated guide data and motion information received from a wearable device, determining exercise content of the exercise program.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating an overview of a wearable device worn on a body of a user according to an embodiment of the disclosure;

FIG. 2 is a diagram illustrating a management system including a wearable device and an electronic device according to an embodiment of the disclosure;

FIG. 3 illustrates a rear schematic view of a wearable device according to an embodiment of the disclosure;

FIG. 4 illustrates a left side view of a wearable device according to an embodiment of the disclosure;

FIGS. 5A and 5B are diagrams illustrating a configuration of a control system of a wearable device according to various embodiments of the disclosure;

FIG. 6 is a diagram illustrating an interaction between a wearable device and an electronic device according to an embodiment of the disclosure;

FIG. 7 is a diagram illustrating a configuration of an electronic device according to an embodiment of the disclosure;

FIG. 8 is a flowchart of a process in which an electronic device generates an exercise program corresponding to target music according to an embodiment of the disclosure;

FIG. 9 is a diagram illustrating a process in which an electronic device generates guide data for an exercise program by analyzing target music according to an embodiment of the disclosure;

FIG. 10 is a diagram illustrating a process in which an electronic device generates intensity guide data of an exercise program based on intensity of sound of target music according to an embodiment of the disclosure;

FIG. 11 is a diagram illustrating a process in which an electronic device determines haptic feedback of an exercise program based on a rhythm pattern of target music according to an embodiment of the disclosure;

FIG. 12 is a diagram illustrating a process in which an electronic device determines exercise content of an exercise program by receiving an exercise record from a wearable device according to an embodiment of the disclosure;

FIG. 13 is a diagram illustrating a process in which an electronic device automatically determines exercise content of an exercise program from a current time point of target music to an end time point of the target music according to an embodiment of the disclosure;

FIG. 14 is a diagram illustrating a process in which an electronic device changes a recorded exercise motion corresponding to exercise intensity of an exercise program or an exercise session according to an embodiment of the disclosure;

FIG. 15 is a diagram illustrating a process in which an electronic device generates and executes an exercise program corresponding to target music according to an embodiment of the disclosure; and

FIG. 16 is a diagram illustrating a process in which an electronic device outputs an avatar on a display while determining exercise content of a target exercise session in an exercise program according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of various the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like components, and any repeated description related thereto will be omitted.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

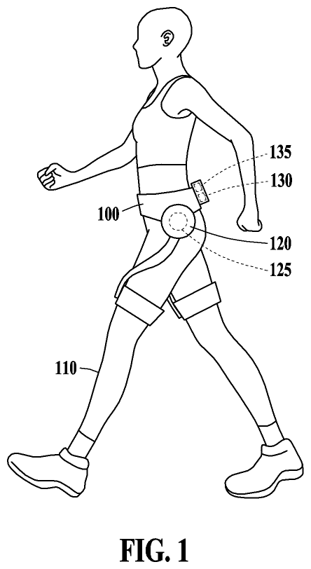

FIG. 1 is a diagram illustrating an overview of a wearable device worn on a body of a user according to an embodiment of the disclosure.

Referring to FIG. 1, a wearable device 100 in an embodiment may be a device worn on a body of a user 110 to assist the user 110 in walking, exercising, and/or working. In an embodiment, the wearable device 100 may be used to measure a physical ability (e.g., a walking ability, an exercise ability, and an exercise posture) of the user 110. In an embodiment, the term “wearable device” may be replaced with “‘wearable robot’”, “walking assistance device”, or “exercise assistance device”. The user 110 may be a human or an animal, but is not limited thereto. The wearable device 100 may be worn on the body (e.g., the lower body (the legs, ankles, knees, etc.), the upper body (the torso, arms, wrists, etc.), or the waist) of the user 110 to provide an external force, such as an assistance force and/or a resistance force, to a body motion of the user 110. The assistance force may be a force assisting the motion of the user 110, which is applied in the same direction as a direction of the body motion of the user 110. The resistance force may be a force hindering the motion of the user 110, which is applied in a direction opposite to the direction of the body motion of the user 110. The term “resistance force” may be also referred to as an “exercise load”.

In an embodiment, the wearable device 100 may operate in a walking assistance mode for assisting the user 110 in walking. In the walking assistance mode, the wearable device 100 may assist the user 110 in walking by applying an assistance force generated by a driving module 120 of the wearable device 100 to the body of the user 110. The wearable device 100 may enable the user 110 to walk independently or to walk for a long time by providing a force required for the user 110 to walk, thereby extending the walking ability of the user 110. The wearable device 100 may help in improving an abnormal walking habit or walking posture of a walker.

In an embodiment, the wearable device 100 may operate in an exercise assistance mode for enhancing the exercise effect of the user 110. In the resistance mode, the wearable device 100 may hinder a body motion of the user 110 or provide resistance to a body motion of the user 110 by applying a resistance force generated by the driving module 120 to the body of the user 110. When the wearable device 100 is a hip-type wearable device worn on the waist (or pelvis) and legs (e.g., thighs) of the user 110, the wearable device 100 may further enhance the exercise effect on the legs of the user 110 by providing an exercise load to a leg motion of the user 110 while the wearable device 100 is worn on the legs. In an embodiment, the wearable device 100 may apply an assistance force to the body of the user 110 to assist the exercise of the user 110. For example, when a person with a disability or an elderly person wears the wearable device 100 to exercise, the wearable device 100 may provide an assistance force to assist a body motion during the exercise. In an embodiment, the wearable device 100 may provide an assistance force and a resistance force in combination for each exercise session or time interval, for example, providing an assistance force in an exercise session and a resistance force in another exercise session.

In an embodiment, the wearable device 100 may operate in a physical ability measurement mode to measure a physical ability of the user 110. The wearable device 100 may measure motion information of the user 110 by using sensors (e.g., an angle sensor 125 or an inertia measurement unit (IMU) 135) included by the wearable device 100 while the user 110 walks or exercises and may evaluate a physical ability of the user 110 based on the measured motion information. For example, a gait index or an exercise ability indicator (e.g., muscular strength, endurance, balance, or exercise motion) of the user 110 may be estimated through the motion information of the user 110 measured by the wearable device 100. The physical ability measurement mode may include an exercise motion measurement mode to measure exercise motion of a user.

In various embodiments herein, the description is provided based on an example in which the wearable device 100 is a hip-type wearable device as shown in FIG. 1, but the embodiments are not limited thereto. As described above, the wearable device 100 may be worn on another body part (e.g., the upper arms, lower arms, hands, calves, and feet) other than the waist and legs (particularly, the thighs), and the shape and configuration of the wearable device 100 may vary depending on the body part on which the wearable device 100 is worn.

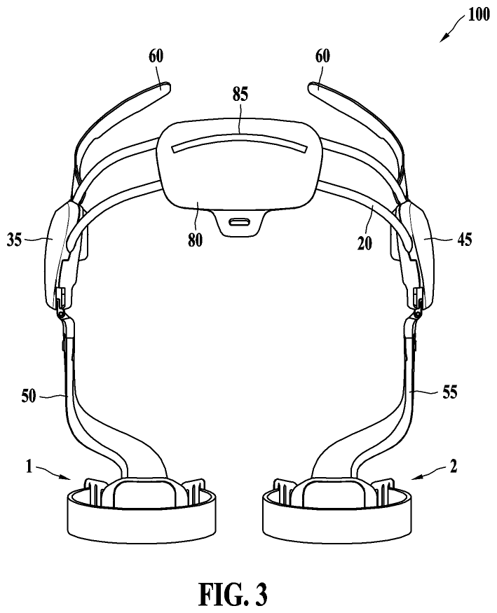

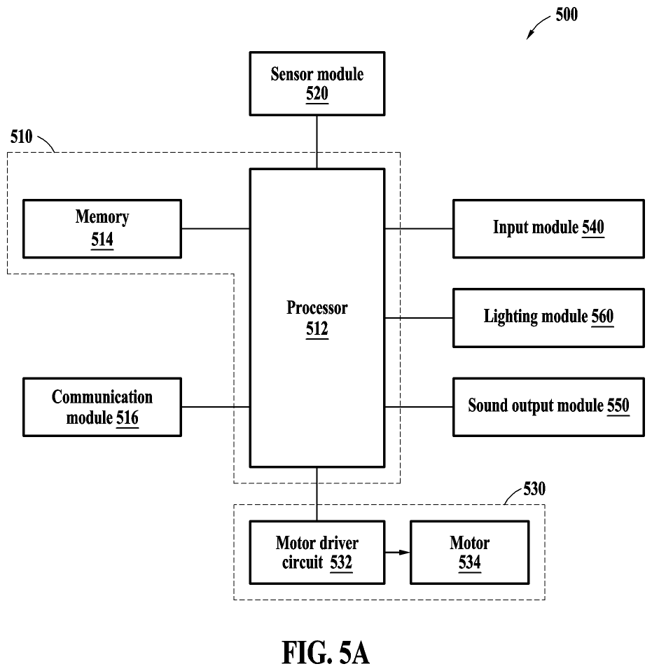

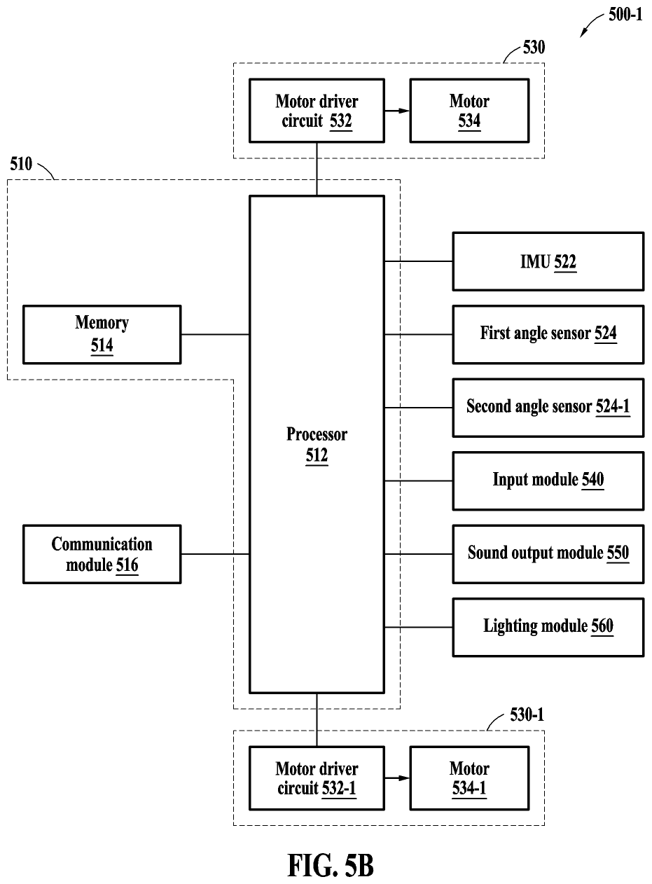

According to an embodiment, the wearable device 100 may include a support frame (e.g., a waist support frame 20) to support the body of the user 110 when the wearable device 100 is worn on the body of the user 110, a driving module 120 (e.g., driving modules 35 and 45 of FIG. 3) for generating a torque applied to the legs of the user 110, a leg driving module (e.g., leg driving modules 50 and 55 of FIG. 3) for delivering a torque generated by the driving module 120 to the legs of the user 110, a sensor module (e.g., a sensor module 520 of FIG. 5A) including one or more sensors to obtain sensor data including motion information about a body motion (e.g., a leg motion or an upper body motion) of the user 110, and a control module 130 (e.g., a control module 510 of FIGS. 5A and 5B) for controlling the wearable device 100.

The sensor module may include an angle sensor 125 and an IMU 135. The angle sensor 125 may measure a rotation angle of the leg driving frame of the wearable device 100 corresponding to a hip joint angle value of the user 110. The rotation angle of the leg driving frame measured by the angle sensor 125 may be estimated as the hip joint angle value (or a leg angle value) of the user 110. The angle sensor 125 may include, for example, an encoder and/or a hall sensor. In an embodiment, the angle sensor 125 may be disposed near a position where a motor included in the driving module 120 is connected to the leg driving frame. The IMU 135 may include an acceleration sensor and/or an angular velocity sensor, and may measure a change in acceleration and/or angular velocity according to a motion of the user 110. The IMU 135 may measure, for example, a motion value of the waist support frame or a base body (e.g., a base body 80 of FIG. 3) of the wearable device 100. The motion value of the waist support frame or base body measured by the IMU 135 may be estimated as an upper body motion value of the user 110.

In an embodiment, the control module 130 and the IMU 135 may be disposed in the base body (e.g., the base body 80 of FIG. 3) of the wearable device 100. The base body may be on the waist (or a lumbar region) of the user 110 when the user 110 wears the wearable device 100. The base body may be formed on or attached to the outside of the waist support frame of the wearable device 100.

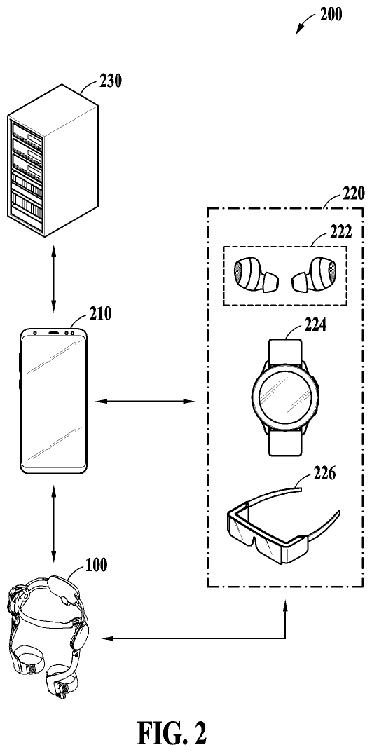

FIG. 2 is a diagram illustrating a management system including a wearable device and an electronic device according to an embodiment of the disclosure.

Referring to FIG. 2, a management system 200 may include the wearable device 100, an electronic device 210, another wearable device 220, and a server 230. In an embodiment, at least one of the devices (e.g., the other wearable device 220 or the server 230) may be omitted from the management system 200 or one or more other devices (e.g., a dedicated controller device for the wearable device 100) may be added to the management system 200.

In an embodiment, in the walking assistance mode, the wearable device 100 may be worn on the body of the user to assist a motion of the user. For example, the wearable device 100 may be worn on the legs of the user and may assist the user in walking by generating the assistance force to assist a leg motion of the user.

In an embodiment, in the exercise assistance mode, the wearable device 100 may generate a resistance force for hindering a body motion of the user or an assistance force for assisting a body motion of the user and may apply the generated resistance or assistance force to the body of the user to enhance the exercise effect of the user. In the exercise assistance mode, the user may select, through the electronic device 210, an exercise program (e.g., squat, split lunge, dumbbell squat, lunge and knee up, stretching, etc.) that the user desires to perform using the wearable device 100 and/or an exercise intensity applied to the wearable device 100. The wearable device 100 may control the driving module of the wearable device 100 according to the exercise program selected by the user and may obtain sensor data including motion information of the user through the sensor module. The wearable device 100 may adjust the strength of the resistance or assistance force applied to the user according to the exercise intensity selected by the user. For example, the wearable device 100 may control the driving module to generate a resistance force corresponding to the exercise intensity selected by the user.

In an embodiment, the wearable device 100 may be used to measure the physical ability of the user by interoperating with the electronic device 210. The wearable device 100 may operate in a physical ability measurement mode, which is a mode for measuring the physical ability of the user under the control of the electronic device 210, and may transmit sensor data obtained by a motion of the user in the physical ability measurement mode to the electronic device 210. The electronic device 210 may evaluate the physical ability of the user by analyzing the sensor data received from the wearable device 100.

The electronic device 210 may communicate with the wearable device 100, may remotely control the wearable device 100, or may provide the user with state information about a state (e.g., a booting state, a charging state, a sensing state, or an error state) of the wearable device 100. The electronic device 210 may receive the sensor data obtained by the sensor module of the wearable device 100 from the wearable device 100 and estimate an exercise result or the physical ability of the user based on the received sensor data. The electronic device 210 may provide the user with the exercise result or the physical ability of the user through a graphical user interface (GUI).

In an embodiment, the user may execute a program (e.g., an application) on the electronic device 210 to control the wearable device 100 and may adjust an operation or a setting value (e.g., the magnitude of torque output from a motor of a driving module (e.g., the driving module 35 or 45 of FIG. 3), the volume of audio output from a sound output module (e.g., a sound output module 550 of FIGS. 5A and 5B), or the brightness of a lighting unit (e.g., a lighting unit 85 of FIG. 3)) of the wearable device 100 via the program. The program executed by the electronic device 210 may provide a GUI for interaction with the user. The electronic device 210 may be various types of devices. The electronic device 210 may include, for example, a portable communication device (e.g., a smartphone), a computer device, a portable multimedia device, or a home appliance, but is not limited thereto.

According to an embodiment, the electronic device 210 may be connected to the server 230 using short-range wireless communication or cellular communication. The server 230 may receive user profile information of the user of the wearable device 100 from the electronic device 210 and may store and manage the received user profile information. The user profile information may include, for example, information about at least one of the name, age, gender, height, weight, or a body mass index (BMI). The server 230 may receive exercise history information about an exercise performed by the user from the electronic device 210 and may store and manage the received exercise history information. The server 230 may provide the electronic device 210 with various exercise programs or physical ability measurement programs to be provided to the user.

According to an embodiment, the wearable device 100 and/or the electronic device 210 may be connected to the other wearable device 220. The other wearable device 220 may be, for example, wireless earphones 222, a smartwatch 224, or smart glasses 226, but is not limited thereto. In an embodiment, the smartwatch 224 may measure a biosignal including heart rate information of the user, and may transmit the measured biosignal to the electronic device 210 and/or the wearable device 100. The electronic device 210 may estimate the heart rate information (e.g., a current heart rate, a maximum heart rate, or an average heart rate) of the user based on the biosignal received from the smartwatch 224 and provide the estimated heart rate information to the user.

In an embodiment, exercise result information, physical ability information, and/or exercise motion evaluation information of the user that are determined by the electronic device 210 may be transmitted to the other wearable device 220 and provided to the user via the other wearable device 220. The state information of the wearable device 100 may be transmitted to the other wearable device 220 and may be provided to the user via the other wearable device 220. In an embodiment, the wearable device 100, the electronic device 210, and the other wearable device 220 may be connected to each other via wireless communication (e.g., Bluetooth communication or wireless fidelity (Wi-Fi) communication).

In an embodiment, the wearable device 100 may provide (or output) feedback (e.g., visual feedback, auditory feedback, or haptic feedback) corresponding to the state of the wearable device 100 according to a control signal received from the electronic device 210. For example, the wearable device 100 may provide visual feedback via a lighting unit (e.g., the lighting unit 85 of FIG. 3) and may provide auditory feedback via a sound output module (e.g., the sound output module 550 of FIGS. 5A and 5B).

FIG. 3 illustrates a rear schematic view of a wearable device according to an embodiment of the disclosure.

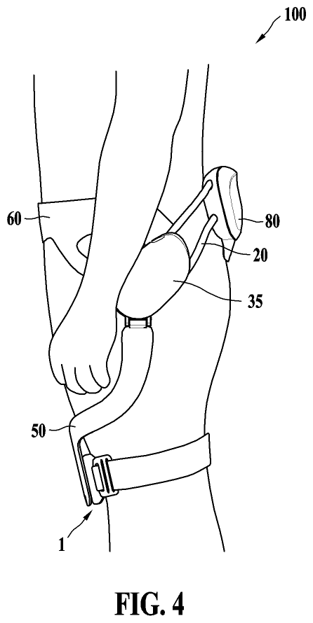

FIG. 4 illustrates a left side view of a wearable device according to an embodiment of the disclosure.

Referring to FIGS. 3 and 4, the wearable device 100 in an embodiment may include a base body 80, a waist support frame 20, driving modules 35 and 45, leg driving frames 50 and 55, thigh fastening portions 1 and 2, and a waist fastening portion 60. The base body 80 may include a lighting unit 85. In an embodiment, at least one (e.g., the lighting unit 85) of the above components may be omitted from the wearable device 100, or one or more other components may be added to the wearable device 100.

The base body 80 may be positioned on the lumbar region of the user while the user is wearing the wearable device 100. The base body 80 may be mounted on the lumbar region of the user to provide a cushioning feeling to the waist of the user and support the waist of the user. The base body 80 may be hung on the hip region (an area of the hips) to prevent the wearable device 100 from being downwardly separated due to gravity while the user is wearing the wearable device 100. The base body 80 may distribute a portion of the weight of the wearable device 100 to the waist of the user while the user is wearing the wearable device 100. The base body 80 may be connected to the waist support frame 20. Waist support frame connecting elements (not shown) for connecting to the waist support frame 20 may be provided at both ends of the base body 80.

In an embodiment, the lighting unit 85 may be disposed on an outer surface of the base body 80. The lighting unit 85 may include a light source (e.g., a light-emitting diode (LED)). The lighting unit 85 may emit light by control of a processor (not shown) (e.g., a processor 512 of FIGS. 5A and 5B). Depending on the embodiment, the processor may control the lighting unit 85 such that visual feedback corresponding to a state of the wearable device 100 may be provided (or output) via the lighting unit 85.

The waist support frame 20 may support the body (e.g., the waist) of the user when the wearable device 100 is worn on the body of the user. The waist support frame 20 may extend from both ends of the base body 80. The lumbar region of the user may be accommodated inside the waist support frame 20. The waist support frame 20 may include at least one rigid body beam. Each beam may be in a curved shape having a preset curvature to enclose the lumbar region of the user. The waist fastening portion 60 may be connected to an end portion of the waist support frame 20. The driving modules 35 and 45 may be connected to the waist support frame 20.

In an embodiment, the processor, memory, an IMU (e.g., the IMU 135 of FIG. 1 or an IMU 522 of FIG. 5B), a communication module (e.g., a communication module 516 of FIGS. 5A and 5B), a sound output module (e.g., the sound output module 550 of FIGS. 5A and 5B), and a battery (not shown) may be disposed inside the base body 80. The base body 80 may protect components disposed therein. The processor may generate a control signal for controlling an operation of the wearable device 100. The processor may control actuators of the driving modules 35 and 45. The processor and the memory may be included in control circuitry. The control circuitry may further include a power supply circuit to supply power from a battery to each component of the wearable device 100.

In an embodiment, the wearable device 100 may include a sensor module (not shown) (e.g., the sensor module 520 of FIG. 5A) configured to obtain sensor data from one or more sensors. The sensor module may obtain sensor data including motion information of the user and/or motion information of a component of the wearable device 100. The sensor module may include, for example, an IMU (e.g., the IMU 135 of FIG. 1 or the IMU 522 of FIG. 5B) configured to measure an upper body motion value of the user or a motion value of the waist support frame 20 and an angle sensor (e.g., the angle sensor 125 of FIG. 1, a first angle sensor 524 and a second angle sensor 524-1 of FIG. 5B) configured to measure a hip joint angle value of the user or a motion value of the leg driving frame 50 or 55, but the example is not limited thereto. For example, the sensor module may further include at least one of a position sensor, a temperature sensor, a biosignal sensor, or a proximity sensor.

The waist fastening portion 60 may be connected to a waist support frame 20 and may fasten the waist support frame 20 to the waist of the user. The waist fastening portion 60 may include, for example, a pair of belts.

The driving modules 35 and 45 may generate an external force (or a torque) applied to the body of the user based on a control signal generated by the processor. For example, the driving modules 35 and 45 may generate an assistance or resistance force applied to the legs of the user. In an embodiment, the driving modules 35 and 45 may include the first driving module 45 positioned corresponding to the position of the right hip joint of the user and the second driving module 35 positioned corresponding to the position of the left hip joint of the user. The first driving module 45 may include a first actuator and a first joint member, and the second driving module 35 may include a second actuator and a second joint member. The first actuator may provide power delivered to the first joint member, and the second actuator may provide power delivered to the second joint member. The first and second actuators may each include a motor (e.g., motors 534 and 534-1 of FIG. 5B) configured to generate power (or torque) by receiving electric power from the battery. When the motor is driven by receiving the electric power, the motor may generate a force (an assistance force) to assist a body motion of the user or a force (a resistance force) to hinder a body motion of the user. In an embodiment, the control module may adjust the strength and direction of the force generated by the motor by adjusting a voltage and/or a current supplied to the motor.

In an embodiment, the first joint member and the second joint member may receive power from the first actuator and the second actuator, respectively, and may apply an external force to the body of the user based on the received power. The first joint member and the second joint member may be disposed at positions corresponding to joint portions of the user, respectively. One side of the first joint member may be connected to the first actuator, and the other side may be connected to the first leg driving frame 55. The first joint member may be rotated by the power received from the first actuator. An encoder or a hall sensor that may function as an angle sensor to measure a rotation angle (corresponding to a joint angle of the user) of the first joint member or the first leg driving frame 55 may be disposed on one side of the first joint member. One side of the second joint member may be connected to the second actuator, and the other side may be connected to the second leg drive frame 50. A second joint member 333 may be rotated by the power received from the second actuator. An encoder or a hall sensor that may function as an angle sensor to measure a rotation angle of the second joint member or the second leg driving frame 50 may also be disposed on one side of the second joint member.

In an embodiment, the first actuator may be disposed in a lateral direction of the first joint member, and the second actuator may be disposed in a lateral direction of the second joint member. A rotation axis of the first actuator and a rotation axis of the first joint member may be spaced apart from each other, and a rotation axis of the second actuator and a rotation axis of the second joint member may also be spaced apart from each other. However, the example is not limited thereto, and the actuator and the joint member may share the rotation axis. In an embodiment, each actuator may be spaced apart from the joint member. In this case, the driving modules 35 and 45 may further include a power transmission module (not shown) configured to transmit power from the actuator to the joint member. The power transmission module may be a rotary body, such as a gear, or a longitudinal member, such as a wire, a cable, a string, a spring, a belt, or a chain. However, the scope of the embodiment is not limited to the positional relationship between the actuator and the joint member and the power transmission structure.

In an embodiment, the leg driving frames 50 and 55 may deliver a torque generated by the driving modules 35 and 45 to the body (e.g., legs) of the user when the wearable device 100 is worn on the legs of the user. The delivered torque may act as an external force applied to a leg motion of the user. As one end portions of the leg driving frames 50 and 55 are connected to the joint members to rotate, and the other end portions of the leg driving frames 50 and 55 are connected to the thigh fastening portions 1 and 2, the leg driving frames 50 and 55 may deliver the torques generated by the driving modules 35 and 45 to the thighs of the user while supporting the thighs of the user. For example, the leg driving frames 50 and 55 may push or pull the thighs of the user. The leg driving frames 50 and 55 may extend in the longitudinal direction of the thighs of the user. The leg driving frames 50 and 55 may be bent to surround at least a portion of the circumferences of the thighs of the user. The leg driving frames 50 and 55 may include the first leg driving frame 55 to deliver a torque to the right leg of the user and the second leg driving frame 50 to deliver a torque to the left leg of the user.

The thigh fastening portions 1 and 2 may be connected to the leg driving frames 50 and 55 and may fasten the wearable device 100 to the legs (specifically, the thighs) of the user. For example, the thigh fastening portions 1 and 2 may include the first thigh fastening portion 2 to fasten the wearable device 100 to the right thigh of the user and the second thigh fastening portion 1 to fasten the wearable device 100 to the left thigh of the user.

In an embodiment, the first thigh fastening portion 2 may include a first cover, a first fastening frame, and a first strap, and the second thigh fastening portion 1 may include a second cover, a second fastening frame, and a second strap. The first cover and the second cover may apply torques generated by the driving modules 35 and 45 to the thighs of the user. The first cover and the second cover may be arranged on one sides of the thighs of the user to push or pull the thighs of the user. For example, the first cover and the second cover may be arranged on the front surfaces of the thighs of the user. The first cover and the second cover may be arranged in the circumferential directions of the thighs of the user. The first cover and the second cover may extend to both sides from the other end portions of the leg driving frames 50 and 55 and may include curved surfaces corresponding to the thighs of the user. One ends of the first cover and the second cover may be connected to the fastening frames, and the other ends thereof may be connected to the straps.

The first fastening frame and the second fastening frame may be arranged, for example, to surround at least some portions of the circumferences of the thighs of the user, thereby preventing the thighs of the user from being separated from the wearable device 100. The first fastening frame may have a fastening structure that connects the first cover to the first strap, and the second fastening frame may have a fastening structure that connects the second cover to the second strap.

The first strap may enclose the remaining portion of the circumference of the right thigh of the user that is not covered by the first cover and the first fastening frame, and the second strap may enclose the remaining portion of the circumference of the left thigh of the user that is not covered by the second cover and the second fastening frame. The first strap and the second strap may include, for example, an elastic material (e.g., a band).

FIGS. 5A and 5B are diagrams illustrating a configuration of a control system of a wearable device according to various embodiments of the disclosure.

Referring to FIG. 5A, a wearable device (e.g., the wearable device 100) may be controlled by a control system 500. The control system 500 may include a control module 510, a communication module 516, a sensor module 520, a driving module 530, an input module 540, a sound output module 550 and a lighting module 560. The driving module 530 may include a motor 534 configured to generate power (e.g., torque) and a motor driver circuit 532 configured to drive the motor 534. The embodiment of FIG. 5A illustrates the driving module 530 including only one motor driver circuit 532 and one motor 534, but this is an example. Referring to FIG. 5B, in a control system 500-1, a plurality (e.g., two or more) of motor driver circuits 532 and 532-1 and a plurality of motors 534 and 534-1 may be provided as the embodiment illustrated in FIG. 5B. The driving module 530 including the motor driver circuit 532 and the motor 534 may correspond to the first driving module 45 of FIG. 3, and a driving module 530-1 including the motor driver circuit 532-1 and the motor 534-1 may correspond to the second driving module 35 of FIG. 3. The descriptions of the motor driver circuit 532 and the motor 534 described below may be applied to the motor driver circuit 532-1 and the motor 534-1 illustrated in FIG. 5B, respectively.

Referring to FIG. 5A, the sensor module 520 may include at least one sensor. The sensor module 520 may include sensor data including motion information of a user or motion information of a wearable device. The sensor module 520 may transmit the obtained sensor data to the control module 510. The sensor module 520 may include an IMU 522 and an angle sensor (e.g., a first angle sensor 524 and a second angle sensor 524-1) as illustrated in FIG. 5B. The IMU 522 may measure an upper body motion value of the user. For example, the IMU 522 may sense acceleration of the X, Y, and Z-axes and angular velocity of the X, Y, and Z-axes according to the motion of the user. In addition, the IMU 522 may obtain a motion value (e.g., an acceleration value and an angular velocity value) of the waist support frame of the wearable device. The angle sensor may measure a hip joint angle value according to a leg motion of the user. The sensor data measured by the angle sensor may include, for example, information about a hip joint angle value of the right leg, a hip joint angle value of the left leg, and a motion direction of the leg. The first angle sensor 524 of FIG. 5B may obtain a hip joint angle value of the right leg of the user, and the second angle sensor 524-1 may obtain a hip joint angle value of the left leg of the user. The first angle sensor 524 and the second angle sensor 524-1 may each include, for example, an encoder and/or a hall sensor. In addition, the first and second angle sensors 520 and 520-1 may obtain motion values of the leg driving frames of the wearable device. For example, the first angle sensor 524 may obtain a motion value of the first leg driving frame 55, and the second angle sensor 524-1 may obtain a motion value of the second leg driving frame 50.

In an embodiment, the sensor module 520 may further include a position sensor for obtaining a position value of the wearable device, a proximity sensor for sensing the proximity of an object, a biosignal sensor for sensing a biosignal of the user, and a temperature sensor for measuring an ambient temperature.

The input module 540 may receive, from the outside (e.g., a user) of the wearable device, an instruction or data to be used by another component (e.g., the processor 512) of the wearable device. The input module 540 may include, for example, a key (e.g., a button) or a touch screen.

The sound output module 550 may output a sound signal to the outside of the wearable device. The sound output module 550 may include a speaker configured to play a guide sound signal (e.g., a driving start sound or an operation error notification sound), music content, or a guiding voice.

In an embodiment, the control system 500 may further include a battery (not shown) for supplying power to each component of the wearable device. The wearable device may convert the power from the battery suitable for an operating voltage of each component of the wearable device and may supply the converted power to each component.

The driving module 530 may generate an external force applied to the legs of the user under the control of the control module 510. The driving module 530 may be disposed at a position corresponding to a hip joint position of the user and may generate a torque applied to the leg of the user based on a control signal generated by the control module 510. The control module 510 may transmit the control signal to the motor driver circuit 532, and the motor driver circuit 532 may control the operation of the motor 534 by generating and providing a current signal (or a voltage signal) corresponding to the control signal to the motor 534. Depending on the control signal, the current signal may not be provided to the motor 534. The motor 534 may generate a force that assists a leg motion of the user or a torque that hinders the leg motion when the motor 534 is driven as the current signal is provided to the motor 534.

The control module 510 may control the overall operation of the wearable device and may generate a control signal for controlling each component (e.g., the driving module 530). The control module 510 may include the processor 512 and memory 514.

The processor 512 may execute, for example, software to control at least one other component (e.g., a hardware or software component) of the wearable device connected to the processor 512 and may perform various data processing or computation. According to an embodiment, as at least a part of data processing or computation, the processor 512 may store instructions or data received from another component (e.g., the communication module 516) in the memory 514, may process the instructions or data stored in the memory 514, and may store resulting data of processing in the memory 514. According to an embodiment, the processor 512 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently from, or in conjunction with the main processor. The auxiliary processor may be implemented separately from the main processor or as a part of the main processor.

The memory 514 may store a variety of data used by at least one component (e.g. the processor 512) of the control module 510. The data may include, for example, software, sensor data, and input data or output data on instructions related thereto. The memory 514 may include volatile memory or non-volatile memory (e.g., random access memory (RAM), dynamic RAM (DRAM), and static RAM (SRAM)).

The communication module 516 may support establishing a direct (e.g., wired) communication channel or a wireless communication channel between the control module 510 and another component of the wearable device or an external electronic device (e.g., the electronic device 210 or the second wearable device 220 of FIG. 2) and performing communication via the established communication channel. For example, the communication module 516 may transmit sensor data obtained by the sensor module 520 to an external electronic device (e.g., the electronic device 210 of FIG. 2) and may receive a control signal from the electronic device. According to an embodiment, the communication module 516 may include one or more CPs that are operated independently of the processor 512 and support direct (e.g., wired) communication or wireless communication. According to an embodiment, the communication module 516 may include a wireless communication module (e.g., a cellular communication module, a short-range wireless communication module, or a global navigation satellite system (GNSS) communication module), and/or a wired communication module. A corresponding one of these communication modules may communicate with another component of the wearable device and/or the external electronic device via a short-range communication network, such as Bluetooth™, wireless-fidelity (Wi-Fi), adaptive network topology (ANT), or infrared data association (IrDA), or a long-range communication network, such as a legacy cellular network, a fifth generation (5G) network, a next-generation communication network, the Internet, or a computer network (e.g., a local area network (LAN) or a wide area network (WAN)).

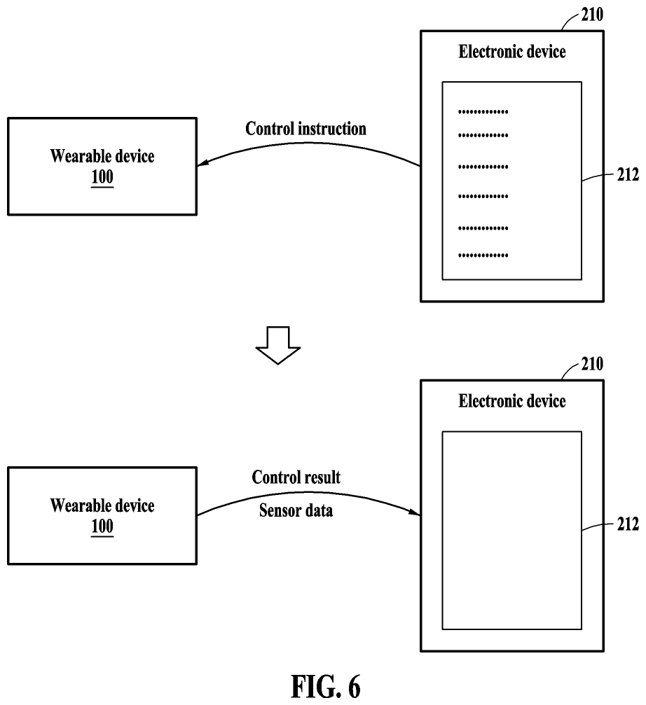

FIG. 6 is a diagram illustrating an interaction between a wearable device and an electronic device according to an embodiment of the disclosure.

Referring to FIG. 6, the wearable device 100 may communicate with the electronic device 210. For example, the electronic device 210 may be a user terminal of the user who uses the wearable device 100 or a controller device dedicated to the wearable device 100. According to an embodiment, the wearable device 100 and the electronic device 210 may be connected to each other via short-range wireless communication (e.g., Bluetooth™ or Wi-Fi communication).

In an embodiment, the electronic device 210 may execute an application for checking a state of the wearable device 100 or controlling or operating the wearable device 100. A screen of a user interface (UI) may be displayed to control an operation of the wearable device 100 or determine an operation mode of the wearable device 100 on a display 212 of the electronic device 210 through the execution of the application. The UI may be, for example, a graphical user interface (GUI).

In an embodiment, the user may input an instruction (e.g., an instruction to execute the walking assistance mode, the exercise assistance mode, or the physical ability measurement mode) to control the operation of the wearable device 100 or change settings of the wearable device 100 via a GUI screen on the display 212 of the electronic device 210. The electronic device 210 may generate a control instruction (or control signal) corresponding to an operation control instruction or a setting change instruction input by the user and may transmit the generated control instruction to the wearable device 100. The wearable device 100 may operate in response to the received control instruction and may transmit, to the electronic device 210, a control result in response to the control instruction and/or sensor data measured by the sensor module of the wearable device 100. The electronic device 210 may provide the user with result information (e.g., walking ability information, exercise ability information, or exercise posture evaluation information) derived by analyzing the control result and/or the sensor data through the GUI screen.

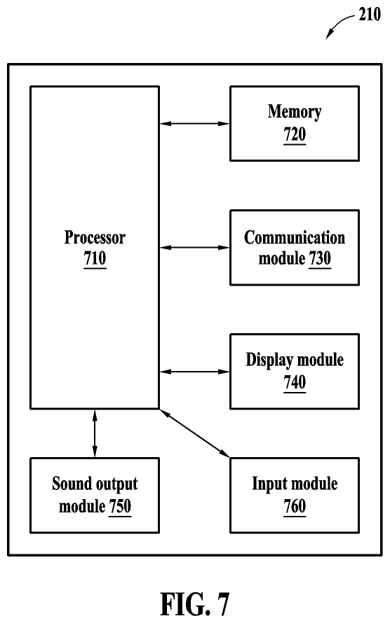

FIG. 7 is a diagram illustrating a configuration of an electronic device according to an embodiment of the disclosure.

Referring to FIG. 7, the electronic device 210 may include a processor 710, memory 720, a communication module 730, a display module 740, a sound output module 750, and an input module 760. In an embodiment, at least one (e.g., the sound output module 750) of the components may be omitted from the electronic device 210 or one or more other components (e.g., a sensor module, a haptic module, or a battery) may be added to the electronic device 210.

The processor 710 may control at least one (e.g., a hardware or software component) component of the electronic device 210 and may perform various data processing or computation. According to an embodiment, as at least a part of data processing or computation, the processor 710 may store instructions or data received from another component (e.g., the communication module 730) in the memory 720, may process the instructions or data stored in the memory 720, and may store resulting data in the memory 720.

According to an embodiment, the processor 710 may include a main processor (e.g., a CPU or an AP) or an auxiliary processor (e.g., a GPU, an NPU, an ISP, a sensor hub processor, or a CP) that is operable independently from, or in conjunction with the main processor.

The memory 720 may store a variety of data used by at least one component (e.g., the processor 710 or the communication module 730) of the electronic device 210. The data may include, a program (e.g., an application) and input data or output data on an instruction related thereto. The memory 720 may include at least one instruction executable by the processor 710. The memory 720 may include volatile memory or non-volatile memory.

The communication module 730 may support establishing a direct (e.g., wired) communication channel or a wireless communication channel between the electronic device 210 and other electronic devices (e.g., the wearable device 100, the other wearable device 220, or the server 230) and performing communication via the established communication channel. The communication module 730 may include communication circuitry for performing a communication function. The communication module 730 may include one or more CPs that are operable independently of the processor 710 (e.g., an AP) and support direct (e.g., wired) communication or wireless communication. According to an embodiment, the communication module 290 may include a wireless communication module (e.g., a Bluetooth communication module, a cellular communication module, a Wi-Fi communication module, or a GNSS communication module) for performing wireless communication or a wired communication module (e.g., a LAN communication module or a power line communication module). For example, the communication module 730 may transmit a control instruction to the wearable device 100 and may receive, from the wearable device 100, at least one of sensor data including body motion information of the user wearing the wearable device 100, state data of the wearable device 100, or control result data corresponding to the control instruction.

The display module 740 may visually provide information to the outside (e.g., the user) of the electronic device 210. The display module 740 may include, for example, a liquid crystal display (LCD) or organic light-emitting diode (OLED) display, a hologram device, or a projector device. The display module 740 may further include a control circuit to control the driving of the display. In an embodiment, the display module 740 may further include a touch sensor adapted to sense a touch or a pressure sensor adapted to measure the intensity of force incurred by the touch. The display module 740 may output a UI screen to control the wearable device 100 or provide various pieces of information (e.g., exercise evaluation information or setting information of the wearable device 100).

The sound output module 750 may output a sound signal to the outside of the electronic device 210. The sound output module 750 may include a speaker configured to play a guide sound signal (e.g., a driving start sound or an operation error notification sound) based on a state of the wearable device 100, music content, or a guiding voice. For example, when it is determined that the wearable device 100 is abnormally worn on the body of the user, the sound output module 750 may output a guide voice to notify or guide the user to wear the wearable device 100 normally.

The input module 760 may receive, from the outside (e.g. the user) of the electronic device 210, an instruction or data to be used by a component (e.g., the processor 710) of the electronic device 210. The input module 760 may include an input component circuit and may receive a user input. The input module 760 may include a touch recognition circuit for recognizing, for example, a key (e.g., a button) and/or a touch on the screen.

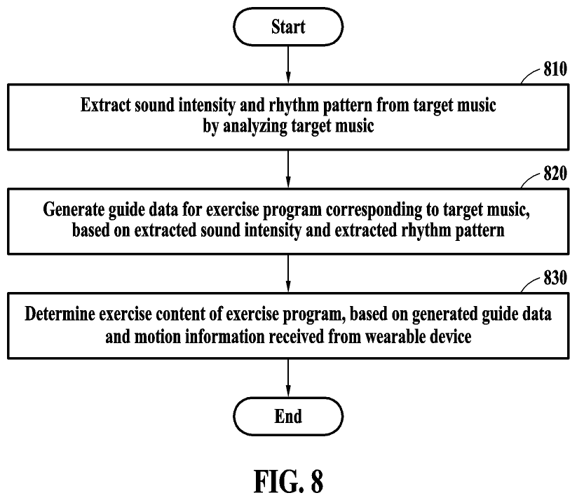

FIG. 8 is a flowchart of a process in which an electronic device generates an exercise program corresponding to target music according to an embodiment of the disclosure.

Referring to FIG. 8, in operation 810, the electronic device may extract sound intensity and a rhythm pattern from target music by analyzing the target music.

In an embodiment, the electronic device may generate an exercise program corresponding to the target music. The user may perform various exercise postures according to the target music by wearing a wearable device through the exercise program corresponding to the target music.

In an embodiment, the electronic device may receive a plurality of candidate music pieces from an external server and may display the plurality of received candidate music pieces on a display. A creator of a music program may select the target music to generate the exercise program from the plurality of candidate music pieces displayed on the display. The electronic device may receive the user's selection of the target music.

In an embodiment, the electronic device may extract a property of the target music by analyzing the target music. More specifically, the electronic device may extract the sound intensity and the rhythm pattern from the target music by analyzing the target music. The sound intensity may represent the amplitude of a sound, and the unit thereof may be expressed in decibels (dB). The electronic device may identify the sound intensity of each of a plurality of notes constituting the target music by extracting the sound intensity from the target music. The rhythm pattern may be formed according to beats and may represent the emphasis and pattern of the music by combining the relative lengths, strengths, and intervals of notes and rests. The electronic device may identify the lengths, strengths, and intervals of notes and rests in the target music by extracting the rhythm pattern from the target music.

In operation 820, the electronic device may generate guide data for the exercise program corresponding to the target music based on the extracted sound intensity and the extracted rhythm pattern. The guide data may be data that helps the creator generate the exercise program more easily. The guide data may include intensity guide data on the exercise intensity to be applied to the wearable device when executing the exercise program and tempo guide data on haptic feedback to be generated in the wearable device when executing the exercise program. In other words, the electronic device may generate the intensity guide data and the tempo guide data as the guide data for the exercise program.

In operation 830, the electronic device may determine exercise content of the exercise program based on the generated guide data and motion information received from the wearable device. The exercise content of the exercise program may include the exercise intensity applied to the wearable device when executing the target music, the haptic feedback to be generated in the wearable device, and an exercise posture to be performed and the number of exercises for each exercise session.

In an embodiment, the creator of the exercise program may wear the wearable device to determine the exercise content of the exercise program. The electronic device may play the target music after generating the guide data, and the creator may perform various exercise postures via the wearable device based on the playback of the target music. When the creator performs an exercise posture via the wearable device, the wearable device may transmit sensor data including the motion information of the wearable device to the electronic device in real time. The electronic device may determine the motion information of the wearable device through the received sensor data and may determine the exercise content of the exercise program by analyzing the motion information of the wearable device.

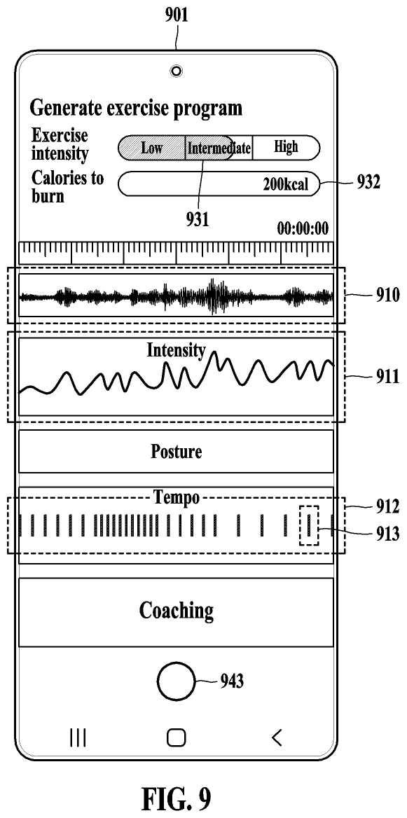

FIG. 9 is a diagram illustrating a process in which an electronic device generates guide data for an exercise program by analyzing target music according to an embodiment of the disclosure.

Referring to FIG. 9, an electronic device 901 may visualize and display a generation status of an exercise program on a display. FIG. 9 is a diagram illustrating a display screen on which an analysis result of target music is displayed before the electronic device 901 receives an exercise record from a wearable device (e.g., the wearable device 100 of FIG. 1).

In an embodiment, the electronic device 901 may generate guide data for an exercise program corresponding to the target music by analyzing the target music. The guide data may include intensity guide data 911 on the exercise intensity to be applied to the wearable device when executing the exercise program and tempo guide data 912 on haptic feedback to be generated in the wearable device when executing the exercise program.

In an embodiment, the electronic device 901 may extract a sound intensity 910 from the target music. The electronic device 901 may generate the intensity guide data 911 based on the extracted sound intensity 910. The intensity guide data 911 may represent information about the exercise intensity to be applied to the wearable device as the target music is played when executing the exercise program. Setting the exercise intensity of “3” to a note constituting the target music in the intensity guide data 911 may indicate setting the exercise intensity applied to the wearable device to the intensity of “3” at the time when the note is played as the target music is played when executing the exercise program. Hereinafter, for ease of description, it is defined that the exercise intensity applied to the wearable device is between 0 and 5. The wearable device may control a driving module (e.g., the driving modules 35 and 45 of FIG. 3) of the wearable device to generate a resistance force having the magnitude corresponding to the exercise intensity.

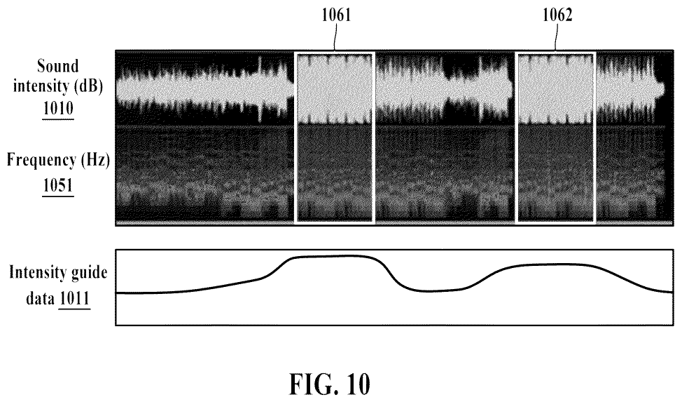

FIG. 10 is a diagram illustrating a process in which an electronic device generates intensity guide data for an exercise program based on the sound intensity in target music according to an embodiment of the disclosure.

Referring to FIG. 10, an electronic device (e.g., the electronic device 901 of FIG. 9) may generate intensity guide data 1011 for an exercise program based on a sound intensity 1010 in target music. The intensity guide data 1011 may include information about exercise intensity corresponding to each note constituting the target music. As the sound intensity of one note increases, the electronic device may set a higher exercise intensity to the note, and as the sound intensity of one note decreases, the electronic device may set a lower exercise intensity to the note. In other words, the electronic device may set the exercise intensity corresponding to a note constituting the target music to the exercise intensity proportional to the sound intensity of the note. For example, the electronic device may set an exercise intensity for a note having a first volume (e.g., 120 dB) in the target music to a first exercise intensity (e.g., the exercise intensity of “4”). The electronic device may set an exercise intensity for a note having a second volume (e.g., 90 dB) that is lower than the first volume to a second exercise intensity (e.g., the exercise intensity of “3”) that is lower than the first exercise intensity.

In an embodiment, the electronic device may individually set a maximum exercise intensity (e.g., the exercise intensity of “4”) and a minimum exercise intensity (e.g., the exercise intensity of “1”) when generating the intensity guide data 1011. The electronic device may match the greatest sound intensity with the maximum exercise intensity from sound intensities of notes constituting the target music and may match the smallest sound intensity with the minimum exercise intensity from the sound intensities of the notes constituting the target music. The electronic device may set the exercise intensity of one note between the maximum exercise intensity and the minimum exercise intensity such that the exercise intensity is proportional to the sound intensity of the note.

In an embodiment, the electronic device may correct the generated intensity guide data 1011 based on the sound intensity in the target music. Hereinafter, various methods of correcting the intensity guide data 1011 by an electronic device are described.

In an embodiment, the electronic device may correct the intensity guide data 1011 based on frequency information 1051 in the target music. Firstly, the electronic device may extract the frequency information 1051 for a plurality of notes constituting the target music. The electronic device may identify chorus intervals 1061 and 1062 of the target music based on the frequency information 1051 extracted from the target music. The electronic device may correct the intensity guide data 1011 by correcting the exercise intensity for the plurality of notes included in the identified chorus intervals 1061 and 1062. In an embodiment, the electronic device may individually increase the exercise intensity of the plurality of notes included in the identified chorus intervals 1061 and 1062 by a preset rate. The preset rate may be 20% but is not limited thereto. For example, when the exercise intensity for a note included in the chorus interval is set to “4” in the intensity guide data 1011, the electronic device may correct the exercise intensity for the note to “4.8” by increasing the exercise intensity by 20%. In another embodiment, the electronic device may correct the intensity guide data 1011 such that the exercise intensities of the plurality of notes included in the identified chorus intervals 1061 and 1062 are set to the maximum exercise intensity (e.g., the exercise intensity of “4”). In another embodiment, the electronic device may correct the intensity guide data 1011 by individually increasing the exercise intensities of the plurality of notes included in the identified chorus intervals 1061 and 1062 by a preset exercise intensity (e.g., the exercise intensity of “1”).

Hereinafter, a process in which the electronic device identifies the chorus intervals 1061 and 1062 of the target music based on the frequency information 1051 extracted from the target music is described. The electronic device may extract a melody of the target music based on the frequency information 1051 of the target music. The melody may represent a temporal progression of pitches of notes. As a frequency of a note increases, a pitch of the note may increase, and as the frequency of the note decreases, the pitch of the note may decrease. The electronic device may determine whether two or more time intervals having similar melodies are present in the entire playback time of the target music. In this case, the time interval may be a section in which one or more bars continue in the target music. The electronic device may compute a similarity of the temporal progression of the pitches of notes in the time intervals, and when the computed similarity is greater than or equal to a threshold similarity, the electronic device may determine that the melodies of the two time intervals are similar. When two or more time intervals having the similar melody are present in the target music, the electronic device may compute the sound intensity of each of the two or more time intervals. The sound intensity of the time interval may represent an average of sound intensities of the plurality of notes included in the time interval. When all sound intensities of the two or more time intervals exceed a threshold intensity, the electronic device may determine that the two or more time intervals are the chorus interval in the target music. For example, the threshold intensity may be an average of sound intensities of notes that fall within the top 20% of sound intensity among the plurality of notes constituting the target music, but the example is not limited thereto.

In an embodiment, the electronic device may segment the entire playback time of the target music into a plurality of time intervals and may correct the intensity guide data 1011 such that an initial exercise intensity remains the same in each segmented time interval. When the exercise intensity applied to the wearable device continuously changes over time, the user who wears the wearable device and performs the exercise according to the exercise program may be confused about how much force to apply to the wearable device. Accordingly, the electronic device may correct the intensity guide data 1011 such that the exercise intensity applied to the wearable device remains the same in the same time interval when playing the target music according to the exercise program. For example, the electronic device may generate a plurality of time intervals by segmenting the entire playback time of the target music into a preset minimum time unit. The preset time may be 3 seconds but is not limited thereto. The electronic device may calculate the average exercise intensity of exercise intensities set to a plurality of notes included in one time interval. The electronic device may calculate the average exercise intensity to be an arithmetic mean of exercise intensities set to the plurality of notes. The electronic device may comprehensively correct the exercise intensity of each of the plurality of notes included in one time interval to the calculated average exercise intensity corresponding to the time interval. In the example described above, the method of generating a plurality of time intervals by segmenting the entire playback time into a preset minimum time unit by the electronic device is described. However, the method of generating the plurality of time intervals is not limited thereto, and the plurality of time intervals may be generated in various methods. For example, the electronic device may set a start time of one time interval as a start time of a first bar in the target music and may set an end time of the time interval as an end time of a second bar in the target music. The first bar may be the same as or different from the second bar. The electronic device may segment the entire playback time of the target music into a plurality of time intervals such that each individual time interval includes a preset minimum time (e.g., 3 seconds) or more.

Referring to FIG. 9, the electronic device 901 may generate the tempo guide data 912 related to haptic feedback to be generated in the wearable device when executing the exercise program, based on a rhythm tempo in the target music. The tempo guide data 912 may represent data related to the tempo and beat of the target music. For example, displaying a line 913 at one time point in the target music in the tempo guide data 912 may indicate that one beat starts at the time point. In other words, in the tempo guide data 912, a line may be displayed at a start time point of a beat in the target music. The electronic device 901 may determine a generation time of the haptic feedback to be generated in the wearable device when playing the target music in the exercise program based on the tempo guide data 912.

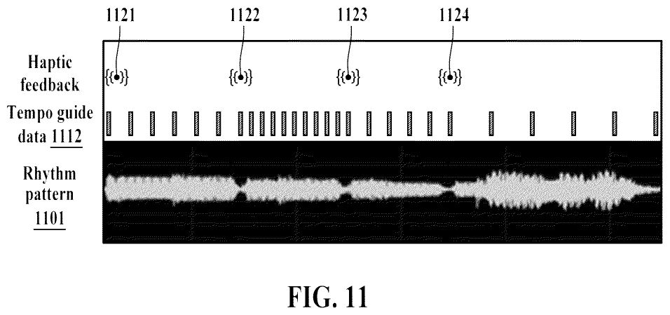

FIG. 11 is a diagram illustrating a process in which an electronic device determines haptic feedback of an exercise program based on a rhythm pattern of target music according to an embodiment of the disclosure.

In an embodiment, an electronic device (e.g., the electronic device 901 of FIG. 9) may generate tempo guide data 1112 for an exercise program based on a rhythm pattern 1101 of target music. The electronic device may determine a generation time of haptic feedback to be generated in a wearable device when executing the exercise program based on the generated tempo guide data 1112. The haptic feedback may refer to a technology that delivers a response to the user by generating vibration in the wearable device. The electronic device may help the user who performs an exercise according to the exercise program performing the exercise smoothly according to the beat based on the haptic feedback generated in the wearable device by determining the generation time of the haptic feedback in the exercise program.

Referring to FIG. 11, the electronic device may identify start times of beats in the target music based on the generated tempo guide data. The electronic device may determine exercise content of the exercise program such that haptic feedbacks 1121, 1122, 1123, and 1124 are generated in the wearable device at some of the identified start times of the beats when playing the target music as the exercise program is executed. Although the disclosure describes the example in which the haptic feedback of the exercise program is generated via the wearable device, the example is not limited thereto, and the haptic feedback may be generated via other devices (e.g., a smartwatch, etc.) connected to the electronic device.

Referring to FIG. 9, when the exercise program corresponding to the target music is generated, the electronic device may receive an input for a target exercise intensity and target calories to burn from a creator of the exercise program. The electronic device may display an interface object 931 corresponding to the target exercise intensity and an interface object 932 corresponding to the target calories to burn on a display. In addition, the electronic device may also display an interface object 943 for receiving an exercise record from the wearable device on the display after analyzing the target music and generating the guide data. The exercise record may include motion information of the wearable device and utterance information of the creator. The creator of the exercise program for the target music may wear the wearable device to perform various exercise postures via the wearable device. When a touch input to the interface object 943 is received, the electronic device may play the target music on the electronic device and the wearable device and may receive the exercise record including the motion information of the wearable device and the utterance information from the wearable device in real time according to the playback of the target music. The electronic device may determine the exercise content of the exercise program corresponding to the target music based on the exercise record received from the wearable device.

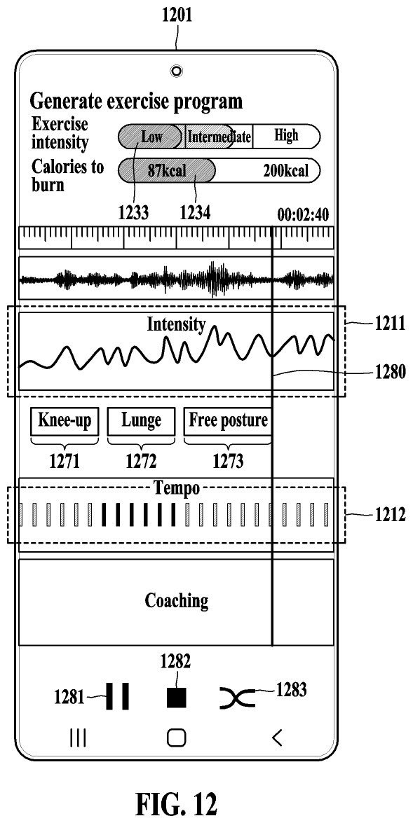

FIG. 12 is a diagram illustrating a process in which an electronic device determines exercise content of an exercise program by receiving an exercise record from a wearable device according to an embodiment of the disclosure.

Referring to FIG. 12, an electronic device 1201 may play target music to determine exercise content of an exercise program after analyzing the target music and generating guide data. The electronic device 1201 may receive motion information of a wearable device (e.g., the wearable device 100 of FIG. 1) in real time according to the playback of the target music.

In an embodiment, the electronic device 1201 may segment the entire playback time of the target music into a plurality of exercise sessions 1271, 1272, and 1273. The electronic device 1201 may determine exercise modes corresponding to the plurality of segmented exercise sessions 1271, 1272, and 1273, respectively. The electronic device 1201 may determine the exercise mode corresponding to one exercise session to be a first mode or a second mode.

Hereinafter, a method of determining an exercise mode of a target exercise session by the electronic device 1201 is described. The first mode may be a mode related to one or more candidate postures among candidate postures stored in the electronic device 1201 in advance. In other words, determining the exercise mode of the target exercise session to be the first mode may indicate that one or more candidate postures stored in the electronic device 1201 are recorded corresponding to the target exercise session. The second mode may be a mode indicating that a mode is not related to the candidate exercise postures stored in the electronic device 1201 in advance. In other words, determining the exercise mode of the target exercise session to be the second mode may indicate that the target exercise session is a free posture session in which a corresponding exercise posture is not recorded.

Storing the candidate postures by the electronic device 1201 may indicate that the wearable device stores the motion information of the wearable device required for the wearable device to perform each candidate posture. For example, storing a lunge posture as a candidate posture by the electronic device 1201 may indicate that the wearable device stores information about a change in a rotation angle of a leg driving frame of the wearable device that is shown when the wearable device performs the lunge posture and acceleration and/or angular velocity information of the wearable device.

In an embodiment, the electronic device 1201 may determine an exercise mode corresponding to the target exercise session based on the motion information received from the wearable device while the target exercise session is played. The electronic device 1201 may determine the exercise mode corresponding to the target exercise session based on determining whether a candidate posture that matches the motion information of the wearable device received while the target exercise session is played exists in the plurality of candidate postures (e.g., a “lunge posture”, a “squat posture”, etc.) stored in the electronic device 1201.

When at least one candidate posture that matches the motion information of the wearable device received while the target exercise session is played exists in the plurality of candidate postures stored in the electronic device 1201, the electronic device 1201 may determine the exercise mode corresponding to the target exercise session to be the first mode for the matching candidate posture. On the other hand, when the candidate posture that matches the motion information of the wearable device received while the target exercise session is played does not exist in the plurality of candidate postures stored in the electronic device 1201, the electronic device 1201 may determine the exercise mode corresponding to the target exercise session to be the second mode indicating the free posture session.

Hereinafter, a process in which the electronic device 1201 determines whether the candidate posture matches the motion information of the wearable device is described. In the motion information of the wearable device received while the target exercise session is played, when motion information that is similar to motion information for the wearable device to perform a candidate posture is detected a threshold number of times or more, the electronic device 1201 may determine that the motion information of the wearable device received while the target exercise session is played matches the candidate posture. In this case, the threshold number of times may be 3, but is not limited thereto. On the other hand, in the motion information of the wearable device received while the target exercise session is played, when motion information that is similar to a plurality of pieces of motion information for the wearable device to perform a plurality of candidate postures is not detected, the electronic device 1201 may determine that a candidate posture that matches the motion information of the wearable device received while the target exercise session is played does not exist. Furthermore, in the motion information of the wearable device received while the target exercise session is played, when motion information that is similar to the motion information for the wearable device to perform a candidate posture is detected once or more or less than the threshold number of times, the electronic device 1201 may output, on the display, an interface to inquire with the creator about whether to determine an exercise posture to be recorded corresponding to the target exercise session to be the candidate posture.

When the electronic device 1201 determines the exercise mode of the target exercise session to be the first mode, an exercise posture that the user needs to perform while the target exercise session is played as the exercise program is executed may be recorded corresponding to the target exercise session. When the electronic device 1201 determines the exercise mode of the target exercise session to be the first mode, the electronic device 1201 may control the wearable device to iteratively perform, until the target exercise session ends, the exercise posture recorded corresponding to the target exercise session while the target exercise session is played as the exercise program is executed. In this case, in the target exercise session, a recession in which the exercise posture is not performed may be set. When the electronic device 1201 determines the exercise mode of the target exercise session to be the second mode, the exercise posture corresponding to the target exercise session may not be separately recorded. Referring to FIG. 12, in the exercise program, the exercise mode of the first exercise session 1271 and the second exercise session 1272 may be determined to be the first mode, and the exercise mode of the third exercise session 1273 may be determined to be the second mode. The lunge posture may be recorded corresponding to the first exercise session 1271, and the knee-up posture may be recorded corresponding to the second exercise session 1272. The third exercise session 1273 may be the free posture session, and the exercise posture corresponding to the third exercise session 1273 may not be separately recorded.

In an embodiment, when the exercise mode corresponding to the target exercise session is determined to be the first mode, the electronic device 1201 may determine the exercise content in the target exercise session of the exercise program such that a resistance force is generated at a position according to the exercise posture recorded corresponding to the target exercise session in the wearable device. For example, when the exercise posture recorded corresponding to the target exercise session is the knee-up posture, the electronic device 1201 may determine the exercise content in the target exercise session of the exercise program such that a posture to apply an exercise load to a right leg motion after an exercise load is applied to a left leg motion in the wearable device is repeated until the target exercise session ends. In this case, the electronic device 1201 may control the driving module of the wearable device to generate the resistance force having the magnitude corresponding to the exercise intensity set to the target exercise session in the intensity guide data 1211 while the target session is played as the exercise program is executed.

In an embodiment, when the exercise mode corresponding to the target exercise session is determined to be the second mode, the electronic device 1201 may not separately designate the position at which the resistance force is generated in the wearable device. When the exercise mode corresponding to the target exercise session is determined to be the second mode, the electronic device 1201 may generate the resistance force at each position that may apply the resistance force in the wearable device. In this case, the electronic device 1201 may control the driving module of the wearable device to generate the resistance force having the magnitude corresponding to the exercise intensity set to the target exercise session in the intensity guide data 1211 while the target session is played as the exercise program is executed.

In an embodiment, the electronic device 1201 may determine that a next exercise session begins after a previous exercise session ends. The electronic device 1201 may determine the time when the exercise session ends (hereinafter, also referred to as the “end time”) in various manners. For example, the electronic device 1201 may determine the time when a preset time has elapsed from the time when an exercise session starts (hereinafter, also referred to as the “start time”) to be the end time of the exercise session. In another example, the electronic device 1201 may also determine that the time when the exercise posture recorded corresponding to an exercise session in the exercise session is repeated a preset number of times (e.g., 30 times) to be the end time of the exercise session. In another example, when the electronic device 1201 receives an instruction to terminate the exercise session from the creator while the exercise session is played, the electronic device 1201 may determine that the time at which the instruction is received to be the end time of the exercise session. In this case, the electronic device 1201 may correct the end time of the exercise session based on tempo guide data 1212. For example, since the electronic device 1201 may identify start times of beats in the target music according to the tempo guide data 1212, the electronic device 1201 may change the end time of the exercise session to be a closest start time of a beat after the end time of the existing exercise session among the start times of the beats.

In an embodiment, the electronic device 1201 may extract an exercise tempo of the wearable device through the motion information of the wearable device. The electronic device 1201 may correct the tempo guide data 1212 based on the extracted exercise tempo of the wearable device. In an embodiment, the electronic device 1201 may correct the tempo guide data 1212 for each exercise session. The electronic device 1201 may obtain an interval at which the exercise posture performed by the wearable device is repeated in the exercise session 1272 through the motion information of the wearable device received while the exercise session 1272 is played. When the extracted interval differs from an interval between the start times of the beats shown in the exercise session 1272 of the tempo guide data 1212 by a threshold time or more, the electronic device 1201 may correct the tempo guide data 1212 in the exercise session 1272. For example, the electronic device 1201 may correct the tempo guide data 1212 such that the interval between the start times of the beats shown in the exercise session 1272 in the tempo guide data 1212 exceeds the obtained interval at which the exercise posture is repeated through the motion information of the wearable device.

In an embodiment, the electronic device 1201 may display a line 1280 indicating a current time at which the target music is played on the display. In addition, while the target music is played, the electronic device 1201 may calculate the average exercise intensity from the start time to the current time of the target music and the total calories burned (e.g., 87 kcal) from the start time to the current time of the target music. The electronic device 1201 may display an interface object 1233 corresponding to the average exercise intensity and an interface object 1234 corresponding to the amount of the total calories burned on the display. For example, the electronic device 1201 may calculate the average exercise intensity to be an arithmetic mean of exercise intensities of notes from the start time to the current time of the target music. For example, the electronic device 1201 may calculate the total calories burned from the start time to the current time based on heart rate information of the creator and the average exercise intensity until the current time. The electronic device may receive the heart rate information of the creator via a smartwatch worn by the creator.

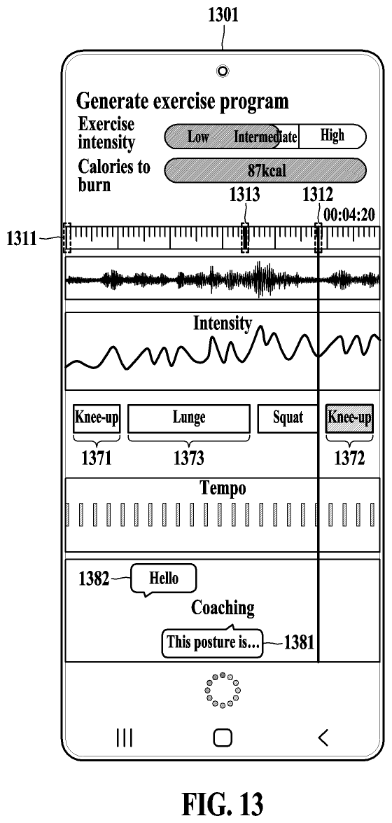

In an embodiment, the electronic device 1201 may display an interface object 1281 for stopping the playback of the target music on the display. When the electronic device 1201 receives a selection of the interface object 1281, the electronic device 1201 may stop receiving the motion information from the wearable device and may pause the determination on the exercise content of the exercise program. In addition, the electronic device 1201 may display an interface object 1282 to stop the determination on the exercise content of the exercise program on the display. Furthermore, the electronic device 1201 may display an interface object 1283 for automatically generating the exercise program on the display. The automatic generation of the exercise program is further described with reference to FIG. 13.

FIG. 13 is a diagram illustrating a process in which an electronic device automatically determines exercise content of an exercise program from a current time point of target music to an end time point of the target music according to an embodiment of the disclosure.

Referring to FIG. 13, an electronic device 1301 may automatically determine exercise content of an exercise program. In other words, the electronic device 1301 may automatically determine the exercise content of the exercise program without receiving motion information of a wearable device from the wearable device. For example, when the electronic device 1301 receives an input to select an interface object (e.g., the interface object 1283 of FIG. 12) for automatically generating an exercise program, the electronic device 1301 may automatically determine the exercise content from a current time 1312 to an end time of target music of the exercise program.

In an embodiment, the electronic device 1301 may determine the exercise content from a start time 1311 to the current time 1312 of the target music of the exercise program based on the motion information received from the wearable device. When the electronic device 1301 receives a request for automatic generation of the exercise program, the electronic device 1301 may determine exercise content from the current time 1312 to an end time (not shown) of the target music of the exercise program based on the determined exercise content from the start time 1311 to the current time 1312 of the target music.

In an embodiment, the electronic device 1301 may extract a melody of the target music based on frequency information (e.g., the frequency information 1051 of FIG. 10) of the target music. The electronic device 1301 may automatically generate the exercise program such that exercise sessions having similar melodies in the target music have the same exercise posture and the same exercise count. Referring to FIG. 13, when a melody of an exercise session 1371 in which an exercise posture and an exercise count is similar to a melody of an exercise session 1372 in which an exercise posture and an exercise count are not determined, the electronic device 1301 may set the exercise posture and the exercise count of the exercise session 1372 to be the same as those of the exercise session 1371. Furthermore, the electronic device 1301 may display, on the display, a minimum time 1313 to receive the motion information of the wearable device from the wearable device while the target music is played to automatically generate the exercise program. Only when the exercise content of the exercise program is determined from the start time 1311 of the target music to the minimum time 1313, the electronic device 1301 may activate an interface object (e.g., the interface object 1283 of FIG. 12) corresponding to the request for automatic generation of the exercise program and may automatically generate the remaining exercise content of the exercise program.

In an embodiment, the electronic device 1301 may embed the utterance information of the creator as the exercise content of the exercise program corresponding to the target music. The electronic device may receive the utterance information in which an utterance of the creator is recorded from the wearable device in real time as the target music is played. The electronic device may analyze the utterance information of the creator to determine whether to embed the utterance information as the exercise content of the exercise program. In an embodiment, when the electronic device 1301 receives the utterance information of the wearable device while the target exercise session is performed, the electronic device 1301 may determine whether to embed the received utterance information as the exercise content of the exercise program based on the determination whether the received utterance information is an utterance related to the exercise posture corresponding to the target exercise session or an exercise order in the target exercise session.

In an embodiment, when the electronic device 1301 determines that utterance information 1381 (e.g., “This posture is a lunge posture”) of the wearable device received while an exercise session 1373 is played is an utterance related to an exercise posture recorded corresponding to the exercise session 1373 or an exercise order in the exercise session 1373, the electronic device 1301 may embed the utterance information 1381 as the exercise content of the exercise program. The electronic device 1301 may store a time point at which the utterance information 1381 is received in the exercise session 1373. The electronic device 1301 may control the wearable device such that the wearable device outputs the utterance information 1381 as a voice through text to speech (TTS) at a time point that is the same as the time point at which the utterance information 1381 is received while the target exercise session is played as the exercise program is executed.

In an embodiment, when the electronic device 1301 determines that utterance information 1382 (e.g., “Hello”) of the wearable device received while an exercise session 1373 is played is an utterance that is not related to the exercise posture recorded corresponding to the exercise session 1373 or the exercise order in the exercise session 1373, the electronic device 1301 may display, on the display, an interface object to inquire whether to embed the utterance information 1382 as the exercise content of the exercise program. When the electronic device 1301 receives a request for embedding the utterance information 1382 as the exercise content of the exercise program from the creator, the electronic device 1301 may store the time point at which the utterance information 1382 is received in the exercise session 1373. The electronic device 1301 may control the wearable device such that the electronic device 1301 or the wearable device outputs the utterance information 1382 as a voice through speech (TTS) at a time point that is the same as the time point at which the utterance information 1382 is received while the target exercise session is played as the exercise program is executed.

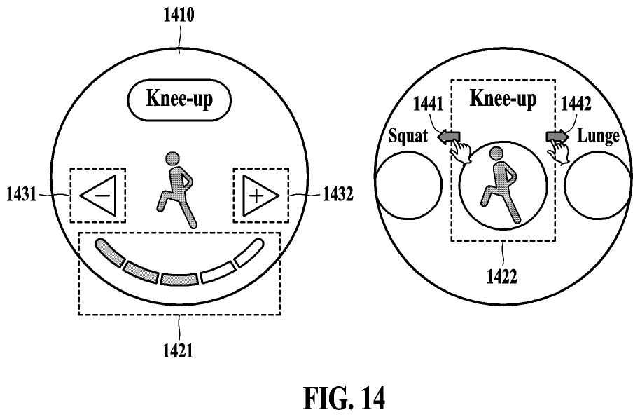

FIG. 14 is a diagram illustrating a process in which an electronic device changes a recorded exercise motion corresponding to exercise intensity of an exercise program or an exercise session according to an embodiment of the disclosure.

Referring to FIG. 14, an electronic device (e.g., the electronic device 901 of FIG. 9) may change the exercise intensity or an exercise posture of an exercise program by receiving an input from a creator while generating the exercise program. FIG. 14 mainly describes an example in which the electronic device receives an input from the creator via a smartwatch 1410 connected to the electronic device. In an embodiment, the electronic device may change at least one of the exercise intensity in a target exercise session of the exercise program and an exercise posture recorded corresponding to the target exercise session, based on the received input from the creator while the target exercise session is played.

For example, when the electronic device plays the target exercise session to determine the exercise content in the target exercise session of the exercise program, an exercise intensity 1421 in the target exercise session according to intensity guide data (e.g., the intensity guide data 911 of FIG. 9) may be displayed on a display of the smartwatch 1410 in real time. The smartwatch 1410 may receive an input to change the exercise intensity at the current time from the creator while the target exercise session is played on the electronic device. For example, the smartwatch 1410 may determine touch inputs to interface objects 1431 and 1432 received from the creator to be inputs to change the exercise intensity. The smartwatch 1410 may transmit the input to change the exercise intensity to the electronic device, and the electronic device may change the exercise intensity 1421 in the target exercise session.

In another example, while the electronic device plays the target exercise session to determine the exercise content in the target exercise session of the exercise program, an exercise posture 1422 recorded corresponding to the target exercise session may be output on the display of the smartwatch 1410 in real time. The smartwatch 1410 may receive an input to change the exercise posture recorded corresponding to the target exercise session from the creator while the target exercise session is played on the electronic device. For example, the smartwatch 1410 may determine swipe inputs 1441 and 1442 received from the creator to be inputs to change the exercise posture recorded corresponding to the target exercise session. The smartwatch 1410 may transmit the input to change the exercise posture to the electronic device, and the electronic device may change the exercise posture 1422 recorded corresponding to the target exercise session.

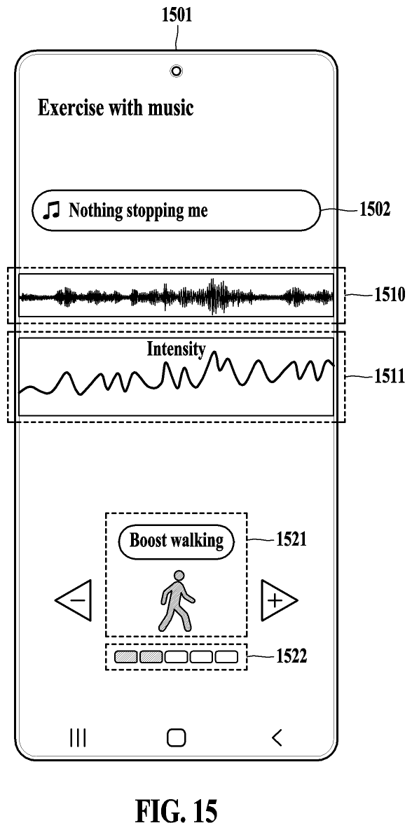

FIG. 15 is a diagram illustrating a process in which an electronic device generates and executes an exercise program corresponding to target music according to an embodiment of the disclosure.

Referring to FIG. 15, an electronic device 1501 may generate an exercise program corresponding to target music 1502 without record information (e.g., motion information and utterance information) received from a wearable device. The electronic device 1501 may extract a sound intensity 1510 and a rhythm tempo (not shown) in the target music 1502 by analyzing the target music 1502. The electronic device 1501 may generate intensity guide data 1511 based on the extracted sound intensity 1510 and may generate haptic guide data based on the extracted rhythm tempo. The electronic device 1501 may determine exercise content of the exercise program using the generated guide data (the intensity guide data 1511 and the haptic guide data).

In an embodiment, when the electronic device 1501 executes the exercise program corresponding to the target music, the electronic device 1501 may apply, to the wearable device, an exercise intensity at an individual time point extracted from the intensity guide data 1511 while the target music is played. In addition, when the electronic device 1501 executes the exercise program corresponding to the target music, the electronic device 1501 may control the wearable device such that haptic feedback based on the haptic guide data is generated in the wearable device while playing the target music. The electronic device 1501 may initially set an exercise posture 1521 to be a default exercise posture (e.g., “boost walking”) in the exercise program and may change the exercise posture 1521 in real time based on a user input while executing the exercise program. The electronic device 1501 may apply an exercise intensity 1522 at an individual time point extracted from the intensity guide data 1511 while the target music is played according to the execution of the exercise program. However, the electronic device 1501 may change the exercise intensity 1522 at the individual time point in real time based on the user input while the target music is played according to the execution of the exercise program.

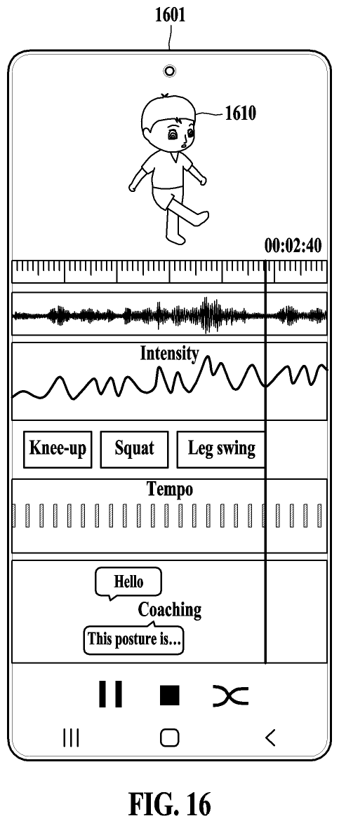

FIG. 16 is a diagram illustrating a process in which an electronic device outputs an avatar on a display while determining exercise content of a target exercise session in an exercise program according to an embodiment of the disclosure.

Referring to FIG. 16, an electronic device 1601 may output an avatar 1610 on a display while generating an exercise program corresponding to target music. The electronic device 1601 may change the appearance and voice of the avatar 1610 based on an input from a creator. While the electronic device 1601 determines exercise content of a target exercise session in the exercise program, the electronic device 1601 may output the avatar 1610 on a display according to an exercise posture recorded corresponding to the target exercise session and utterance information embedded in the target exercise session. For example, while the target exercise session is played to determine the exercise content in the target exercise session, the electronic device 1601 may generate, on the display, an image effect in which the avatar 1610 performs an exercise posture recorded corresponding to the target exercise session. In addition, while the target exercise session is played to determine the exercise content in the target exercise session, the electronic device 1601 may generate a voice effect, in which a voice corresponding to the utterance information embedded in the target exercise session is output as the voice of the avatar 1610, on the display.

Furthermore, while the target exercise session is played according to the execution of the exercise program corresponding to the target music, the electronic device 1601 may generate the image effect in which the avatar 1610 performs the exercise posture recorded corresponding to the target exercise session and the voice effect in which the voice corresponding to the utterance information embedded in the target exercise session is output as the voice of the avatar 1610, in the electronic device 1601.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. Terms such as “first,” “second,” “first,” or “second” may be used simply to distinguish one component from another and may not limit the components with respect to other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

As used in connection with embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums. Embodiments as set forth herein may be implemented as software including one or more instructions that are stored in a storage medium (e.g., the memory 514) that is readable by a machine. For example, a processor of the machine may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. The term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added.

Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
communication circuitry connected to a wearable device to receive sensor data including motion information of the wearable device;
memory, comprising one or more storage media, storing instructions; and
one or more processors electrically connected to the communication circuitry and the memory,
wherein the instructions, when executed by the one or more processors individually or collectively, cause the electronic device to:
extract a sound intensity and rhythm pattern in target music by analyzing the target music,
based on the extracted sound intensity and the extracted rhythm pattern, generate guide data on an exercise program corresponding to the target music, and
based on the generated guide data and motion information received from the wearable device, determine exercise content of the exercise program.

2. The electronic device of claim 1, wherein the instructions, when executed by the one or more processors individually or collectively, further cause the electronic device to:
based on the extracted sound intensity, generate intensity guide data on an exercise intensity to be applied to the wearable device when the exercise program is executed, and
based on the extracted rhythm tempo, generate tempo guide data on haptic feedback to be generated in the wearable device when the exercise program is executed.

3. The electronic device of claim 1, wherein the instructions, when executed by the one or more processors individually or collectively, further cause the electronic device to:
extract frequency information on a plurality of notes forming the target music,
identify a chorus interval of the target music based on the extracted frequency information, and
correct the generated intensity guide data by correcting an exercise intensity for a note included in the identified chorus interval.

4. The electronic device claim 1, wherein the instructions, when executed by the one or more processors individually or collectively, further cause the electronic device to:
identify start times of beats in the target music based on the generated tempo guide data, and
determine the exercise content of the exercise program such that a haptic feedback is generated in the wearable device at some of the identified start times when the exercise program is executed.

5. The electronic device of claim 1, wherein the instructions, when executed by the one or more processors individually or collectively, further cause the electronic device to:
play the target music after generating the guide data, and
receive the motion information of the wearable device from the wearable device in real time according to playback of the target music.

6. The electronic device of claim 1, wherein the instructions, when executed by the one or more processors individually or collectively, further cause the electronic device to:
segment an entire playback time of the target music into a plurality of exercise sessions, and
determine an exercise mode corresponding to each of a plurality of segmented exercise sessions to be one of a first mode or a second mode.

7. The electronic device of claim 6, wherein the instructions, when executed by the one or more processors individually or collectively, further cause the electronic device to:
based on determining whether a candidate posture that matches the motion information of the wearable device received while a target exercise session is played exists in a plurality of candidate postures stored in the electronic device, determine an exercise mode corresponding to the target exercise session.

8. The electronic device of claim 7, wherein the instructions, when executed by the one or more processors individually or collectively, further cause the electronic device to:
when the candidate posture that matches the motion information of the wearable device received while the target exercise session is played exists, determine the exercise mode corresponding to the target exercise session to be a first mode related to the matching candidate posture, and
when the candidate posture that matches the motion information of the wearable device received while the target exercise session is played does not exist, determine the exercise mode corresponding to the target exercise session to be the second mode indicating a free posture session.

9. The electronic device of claim 8, wherein the instructions, when executed by the one or more processors individually or collectively, further cause the electronic device to:
when the exercise mode corresponding to the target exercise session is determined to be the first mode, determine the exercise content of the exercise program such that a resistance force is generated at a position according to an exercise posture that is recorded corresponding to the target exercise session in the wearable device when the target exercise session is played according to execution of the exercise program.

10. The electronic device of claim 9, wherein the instructions, when executed by the one or more processors individually or collectively, further cause the electronic device to:
determine exercise content from a start time to a current time of the target music of the exercise program based on the motion information received from the wearable device, and
when a request for automatic generation of the exercise program is received, determine exercise content from the current time to an end time of the target music of the exercise program based on the determined exercise content.

11. The electronic device of claim 10, wherein the instructions, when executed by the one or more processors individually or collectively, further cause the electronic device to:
when utterance information of the wearable device is received while the target exercise session is performed, determine whether to embed the received utterance information as the exercise content of the exercise program, based on determining whether the received utterance information is an utterance related to the exercise posture recorded corresponding to the target exercise session or an exercise order in the target exercise session.

12. The electronic device of claim 11, wherein the instructions, when executed by the one or more processors individually or collectively, further cause the electronic device to:
when the received utterance information is embedded as the exercise content of the exercise program, determine the exercise content of the exercise program such that the wearable devices output the received utterance information through text to speech (TTS) when the target exercise session is played according to the execution of the exercise program.

13. The electronic device of claim 12, wherein the instructions, when executed by the one or more processors individually or collectively, further cause the electronic device to:
based on a creator input received while the target exercise session is played, change at least one of an exercise intensity in the target exercise session of the exercise program or the exercise posture recorded corresponding to the target exercise session.

14. The electronic device of claim 13, wherein the instructions, when executed by the one or more processors individually or collectively, further cause the electronic device to:
while determining the exercise content of the target exercise session in the exercise program, display an avatar on a display according to the exercise posture recorded corresponding to the target exercise session and the utterance information embedded in the target exercise session.

15. A method performed by a processor of an electronic device, the method comprising:
extracting a sound intensity and rhythm pattern in target music by analyzing the target music;
based on the extracted sound intensity and the extracted rhythm pattern, generating guide data on an exercise program corresponding to the target music; and
based on the generated guide data and motion information received from a wearable device, determining exercise content of the exercise program.

16. The method of claim 15, further comprising:
based on the extracted sound intensity, generating intensity guide data on an exercise intensity to be applied to the wearable device when the exercise program is executed; and
based on the extracted rhythm tempo, generating tempo guide data on haptic feedback to be generated in the wearable device when the exercise program is executed.

17. The method of claim 15, further comprising:
extracting frequency information on a plurality of notes forming the target music;
identifying a chorus interval of the target music based on the extracted frequency information; and
correcting the generated intensity guide data by correcting an exercise intensity for a note included in the identified chorus interval.

18. The method of claim 15, further comprising:
identifying start times of beats in the target music based on the generated tempo guide data; and
determining the exercise content of the exercise program such that a haptic feedback is generated in the wearable device at some of the identified start times when the exercise program is executed.

19. One or more non-transitory computer-readable storage media storing one or more computer programs including computer-executable instructions that, when executed by one or more processors of an electronic device individually or collectively, cause the electronic device to perform operations, the operations comprising:
extracting a sound intensity and rhythm pattern in target music by analyzing the target music;
based on the extracted sound intensity and the extracted rhythm pattern, generating guide data on an exercise program corresponding to the target music; and
based on the generated guide data and motion information received from a wearable device, determining exercise content of the exercise program.

20. The one or more non-transitory computer-readable storage media of claim 19, the operations further comprising:
based on the extracted sound intensity, generating intensity guide data on an exercise intensity to be applied to the wearable device when the exercise program is executed; and
based on the extracted rhythm tempo, generating tempo guide data on haptic feedback to be generated in the wearable device when the exercise program is executed.
